(19) United States
(12) Patent Application Publication
(10) Pub. No.: US 2024/0212397 A1
(43) Pub. Date: Jun. 27, 2024

(54) VEHICLE MANAGEMENT METHOD, VEHICLE MANAGEMENT SYSTEM, AND COMPUTER SYSTEM

(71) Applicant: TOYOTA JIDOSHA KABUSHIKI KAISHA, Toyota-shi (JP)

(72) Inventors: Yuko TERASAWA, Tokyo (JP); Tomoyoshi UEKI, Toyota-shi (JP); Masahiro KAGAMI, Nagoya-shi (JP); Yasuhide KURIMOTO, Kasugai-shi (JP); Hiroshi YAMASAKI, Nagoya-shi (JP); Kenji ZAITSU, Nisshin-shi (JP); Yoshihiko ENDO, Tokyo (JP)

(73) Assignee: TOYOTA JIDOSHA KABUSHIKI KAISHA, Toyota-shi (JP)

(21) Appl. No.: 18/526,056

(22) Filed: Dec. 1, 2023

(30) Foreign Application Priority Data
Dec. 27, 2022 (JP) 2022-210083

(51) Int. Cl. G07C 5/00

(52) U.S. Cl. CPC G07C 5/008

(57) ABSTRACT

A vehicle management method includes: determining whether a power storage device provided in a vehicle has been replaced; and determining whether replacement of the power storage device has been performed in an unauthorized manner when a determination that the power storage device has been replaced is made, wherein the determining as to whether the replacement has been performed in an unauthorized manner includes determining whether the replacement has been performed at an authorized site.

### CROSS-REFERENCE TO RELATED APPLICATION

This application claims priority to Japanese Patent Application No. 2022-210083 filed on Dec. 27, 2022, incorporated herein by reference in its entirety.

### BACKGROUND

### 1. Technical Field

The present disclosure relates to a vehicle management method, a vehicle management system, and a computer system.

### 2. Description of Related Art

Japanese Unexamined Patent Application Publication (Translation of PCT Application) No. 2010-540907 (JP 2010-540907 A) discloses that a user is provided with a vehicle equipped with a battery not owned by the user (e.g. a battery owned by a battery manager), and that the battery mounted on the vehicle is replaced by a battery replacement station.

### SUMMARY

JP 2010-540907 A does not discuss at all the possibility that the battery (power storage device) mounted on the vehicle may be replaced in an unauthorized manner. In the vehicle management system described in JP 2010-540907 A, a loss may be caused to the battery owner or the vehicle may not operate normally when the battery mounted on the vehicle is replaced in an unauthorized manner.

The present disclosure provides a vehicle management method, a vehicle management system, and a computer system that allow confirming whether a power storage device mounted on a vehicle has been replaced in an unauthorized manner.

A first aspect of the present disclosure provides a vehicle management method to be described below. The vehicle management method includes: determining whether a power storage device provided in a vehicle has been replaced; and determining whether replacement of the power storage device has been performed in an unauthorized manner when a determination that the power storage device has been replaced is made, wherein the determining as to whether the replacement has been performed in an unauthorized manner includes determining whether the replacement has been performed at an authorized site.

When the power storage device mounted on the vehicle has not been replaced at an authorized site, there is a high possibility that the power storage device mounted on the vehicle has been replaced in an unauthorized manner. Therefore, with the above method, it is possible to adequately confirm whether the power storage device mounted on the vehicle has been replaced in an unauthorized manner based on whether the replacement of the power storage device has been performed at an authorized site.

The power storage device may be owned by an entity other than a vehicle user. The authorized site is a site at which replacement of the power storage device is performed in an authorized manner. Replacement of the power storage device is permitted at the authorized site. The authorized site may be a site managed by an owner of the power storage device. The authorized site may be a dealer or a battery replacement station that is present within the coverage of the owner of the power storage device, for example.

The vehicle management method according to the first aspect may be configured as described below.

The vehicle management method according to the first aspect further includes the following features. The determining as to whether the power storage device has been replaced may include acquiring data about the power storage device measured in the vehicle, and determining whether the power storage device has been replaced based on whether the data have become discontinuous. The determining as to whether the replacement has been performed in an unauthorized manner may include determining whether the replacement has been performed in an authorized manner based on whether a position of the vehicle at a time when the data have become discontinuous is the authorized site.

In the above method, it is determined whether the power storage device has been replaced based on whether the data about the power storage device have become discontinuous in the vehicle. With such a method, it is easy to adequately determine whether the power storage device has been replaced. In the above method, further, it is determined whether the replacement has been performed in an authorized manner based on whether the position of the vehicle at the time when the data have become discontinuous is an authorized site. Consequently, it is easy to adequately determine whether the replacement has been performed in an unauthorized manner.

The data about the power storage device may be detected by a sensor mounted on the vehicle. The data about the power storage device may include at least one of temperature data that indicate transitions in the temperature of the power storage device, current data that indicate transitions in the current of the power storage device, voltage data that indicate transitions in the voltage of the power storage device, and remaining stored power amount data that indicate transitions in the remaining stored power amount of the power storage device.

The vehicle management method according to the first aspect further includes the following features. The data about the power storage device may include remaining stored power amount data that indicate transitions in a remaining stored power amount of the power storage device. The determining as to whether the power storage device has been replaced may include determining whether the remaining stored power amount data have become discontinuous based on whether the remaining stored power amount data include a time when the remaining stored power amount of the power storage device is increased by a predetermined amount or more while the power storage device is not being charged.

The remaining stored power amount of the power storage device is occasionally decreased through natural discharge, even if the power storage device is not used. On the other hand, it is considered that the remaining stored power amount of the power storage device is not significantly increased while the power storage device is not being charged, unless the power storage device is replaced. With the above method, it is easy to adequately determine whether the power storage device has been replaced.

The vehicle management method according to the first aspect may further include executing at least one of processes of recording that unauthorized replacement has been performed, making a notification that unauthorized replacement has been performed, and restricting use of the vehicle when a determination that the replacement has been performed in an unauthorized manner is made.

With the above method, it is possible to suppress continued use of the vehicle to which an unauthorized power storage device has been attached when replacement of the power storage device has been performed in an unauthorized manner. The process of restricting use of the vehicle may be a process of prohibiting predetermined control in the vehicle, or may be a process of restricting output from the unauthorized power storage device.

The vehicle management method according to the first aspect may further include setting an upper limit value that restricts output power of an unauthorized power storage device attached to the vehicle through unauthorized replacement when a determination that the replacement has been performed in an unauthorized manner is made.

With the above method, use of an unauthorized power storage device can be restricted when replacement of the power storage device has been performed in an unauthorized manner. The upper limit value may be fixed, or may be variable in accordance with a predetermined parameter (e.g. vehicle type, vehicle position, or outside temperature). For example, the upper limit value at the time when the vehicle includes a power source other than the unauthorized power storage device may be smaller than the upper limit value at the time when the vehicle does not include a power source other than the unauthorized power storage device. When the vehicle includes a power source other than the unauthorized power storage device, the vehicle is movable even if the unauthorized power storage device is completely useless, and therefore the user can drive the vehicle to the authorized site in order to have the unauthorized power storage device replaced.

The vehicle management method according to the first aspect may further include, when a determination that the replacement has been performed in an unauthorized manner is made, notifying a user of the vehicle to suggest replacing an unauthorized power storage device attached to the vehicle through unauthorized replacement and charging the user of the vehicle a cost for replacement of the unauthorized power storage device.

In the above method, the vehicle user that has performed the unauthorized replacement is charged the cost for the replacement of the unauthorized power storage device. Consequently, unauthorized replacement can be suppressed.

A certain aspect provides a program that causes a computer to execute the vehicle management method according to the first aspect. Another aspect provides a computer device that distributes the program.

A second aspect of the present disclosure provides a computer system to be described below.

The computer system may include: one or more processors; and one or more storage devices that store a program that causes the one or more processors to execute the vehicle management method according to the first aspect.

With the above computer system, the vehicle management method discussed earlier is executed suitably. The above computer system may include a plurality of processors mounted on separate computers and a plurality of storage devices mounted on separate computers. For example, the above computer system may include a processor and a storage device mounted on a vehicle and a processor and a storage device mounted a stationary server.

A third aspect of the present disclosure provides a vehicle management system to be described below.

The vehicle management system includes: a vehicle that includes a power storage device and an electronic control device; and a server configured to communicate with the vehicle, wherein the electronic control device is configured to measure and record data about the power storage device, determine whether the data have become discontinuous because of replacement of the power storage device, and transmit a signal that indicates a position of the vehicle at a time when the data have become discontinuous to the server when a determination that the data have become discontinuous is made, and the server is configured to determine whether the position of the vehicle indicated by the signal is an authorized site determined in advance when the signal is received, and restrict use of the vehicle when the position of the vehicle indicated by the signal is not the authorized site.

With the above system, the vehicle management method discussed earlier is executed suitably.

The vehicle management system according to the third aspect may further include the following features. The vehicle may be configured to travel using power output from the power storage device; the vehicle may further include an auxiliary battery that supplies power to a power source circuit of the electronic control device; the power storage device may be configured to supply power to the auxiliary battery; and when the electronic control device is brought into a stopped state with the auxiliary battery disconnected from the power source circuit and thereafter the electronic control device is started with the auxiliary battery connected to the power source circuit again, the electronic control device may be configured to determine whether the data have become discontinuous because of replacement of the power storage device by comparing the data recorded immediately before start of the electronic control device and the data recorded immediately after the start.

There is a high possibility that the auxiliary battery supplied with power from the power storage device for travel (e.g. a main battery) is disconnected from an in-vehicle circuit before the work of replacing the power storage device is performed. For example, a wire connecting the auxiliary battery and the in-vehicle circuit and connected to a terminal (using e.g. a bolt or a connector) is disconnected. When the auxiliary battery is disconnected from the in-vehicle circuit (including the power source circuit of the control device), the control device supplied with power from the auxiliary battery is brought into a stopped state. After that, when replacement of the power storage device is completed, the control device is started with the auxiliary battery connected to the power source circuit again. In the above system, it is determined whether the data about the power storage device have become discontinuous because of replacement of the power storage device when the control device is started after the auxiliary battery is disconnected from the power source circuit once and connected to the power source circuit again. It is easy to determine quickly and accurately whether the power storage device has been replaced, by making the above determination at a timing when it is highly likely that replacement of the power storage device has been performed.

A fourth aspect of the present disclosure provides a vehicle management system to be described below.

The vehicle management system includes: a vehicle that includes a power storage device and an electronic control device; and a server configured to communicate with the vehicle, wherein the electronic control device is configured to transmit, to the server, a measurement result of each of data about the power storage device and a position of the vehicle together with a measurement time, and the server is configured to save the data about the power storage device and the position of the vehicle received from the vehicle together with the measurement time, determine whether the saved data about the power storage device have become discontinuous because of replacement of the power storage device, determine whether the position of the vehicle at a time when the data have become discontinuous is an authorized site determined in advance when a determination that the data have become discontinuous, and restrict use of the vehicle when the position of the vehicle at the time when the data have become discontinuous is not the authorized site.

With the above system, the vehicle management method discussed earlier is executed suitably. The above vehicle may be an electrified vehicle (xEV) that uses electric power in all or a part of power sources. Examples of the xEV include a battery electric vehicle (BEV), a plug-in hybrid electric vehicle (PHEV), a hybrid electric vehicle (HEV), a fuel cell electric vehicle (FCEV), etc.

With the present disclosure, it is possible to provide a vehicle management method, a vehicle management system, and a computer system that allow confirming whether a power storage device mounted on a vehicle has been replaced in an unauthorized manner.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating an overview of a vehicle management system according to an embodiment of the present disclosure;

FIG. 2 is a diagram illustrating the configuration of a vehicle illustrated in FIG. 1;

FIG. 3 is a flowchart illustrating a vehicle management method according to the embodiment of the present disclosure;

FIG. 4 is a flowchart illustrating a first modification of the process illustrated in FIG. 3;

FIG. 5 is a flowchart illustrating a second modification of the process illustrated in FIG. 3;

FIG. 6 is a flowchart illustrating the details of restriction control illustrated in FIG. 5;

FIG. 7 is a flowchart illustrating a third modification of the process illustrated in FIG. 3; and

FIG. 8 is a flowchart illustrating a fourth modification of the process illustrated in FIG. 3.

### DETAILED DESCRIPTION OF EMBODIMENTS

An embodiment of the present disclosure will be described in detail with reference to the drawings. The same or corresponding parts are denoted by the same signs throughout the drawings, and description thereof will not be repeated.

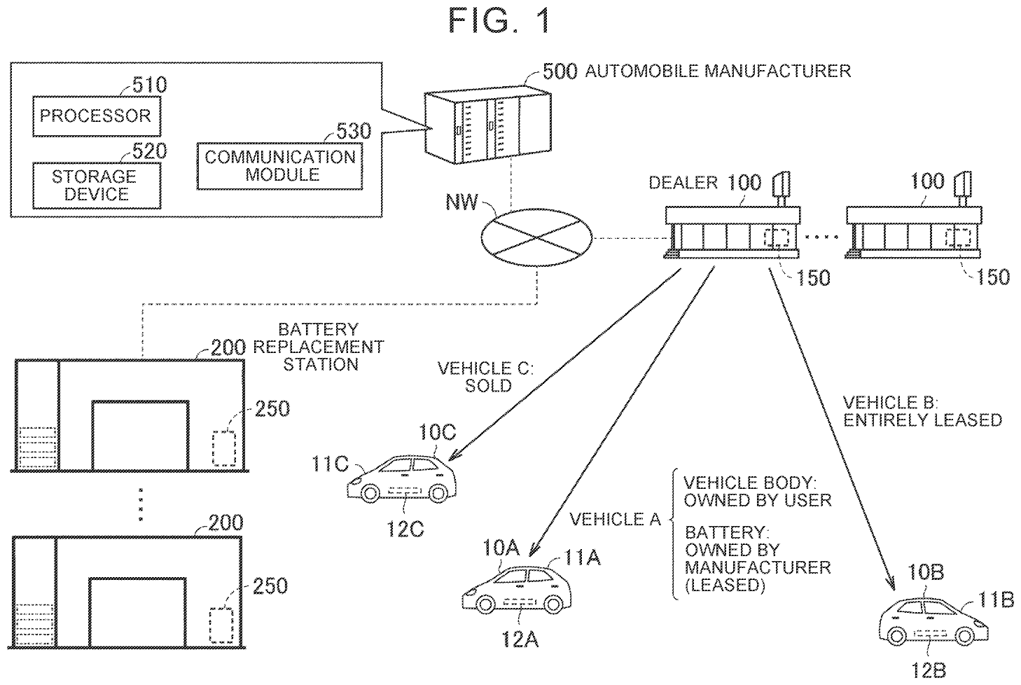

FIG. 1 is a diagram illustrating an overview of a vehicle management system according to this embodiment. The vehicle management system illustrated in FIG. 1 includes dealers 100, battery replacement stations (hereinafter denoted as “BSta”) 200, and a management center 500.

The management center 500 is a server that provides a lease service for automobiles. The management center 500 manages information about the lease service. The management center 500 belongs to an automobile manufacturer, for example. In this embodiment, the automobile manufacturer also acts as a lease business operator.

The management center 500 includes a processor 510, a storage device 520, and a communication module 530. The processor 510 includes a central processing unit (CPU), for example. The storage device 520 is configured to be able to save stored information. The storage device 520 may include a hard disk (HD) drive or a solid state drive (SSD). The communication module 530 is connected to a communication network NW through a wire, for example. The dealers 100 each include a server 150. The BSta 200 each include a server 250. Each of the servers 150 and 250 is also connected to the communication network NW through a wire, for example. The management center 500, the servers 150, and the servers 250 are configured to be communicable with each other via the communication network NW. The communication network NW is a wide area network built by the Internet and wireless base stations, for example. The communication network NW may include a cellular telephone network.

An automobile manufacturer sells or leases manufactured vehicles through the dealers 100. In this embodiment, a plurality of types of leasing methods including partial leasing and entire leasing is adopted. The server 150 manages information (vehicle information) about vehicles provided from the dealer 100 as distinguished by a vehicle identifier (ID). The server 150 consecutively transmits the latest vehicle information to the management center 500. A power storage device 12A of a vehicle 10A (vehicle A) illustrated in FIG. 1 may be leased to a user through partial leasing, for example. Of the vehicle 10A (partially leased vehicle), a vehicle body 11A belongs to the user, and the power storage device 12A belongs to the automobile manufacturer. Alternatively, a vehicle 10B (vehicle B) illustrated in FIG. 1 may be leased to a user through entire leasing. Of the vehicle 10B (entirely leased vehicle), the entire vehicle (vehicle body 11B and power storage device 12B) belongs to the automobile manufacturer. Alternatively, a vehicle 10C (vehicle C) illustrated in FIG. 1 may be sold to a user. Of the vehicle 10C (sold vehicle), the entire vehicle (vehicle body 11C and power storage device 12C) belongs to the user.

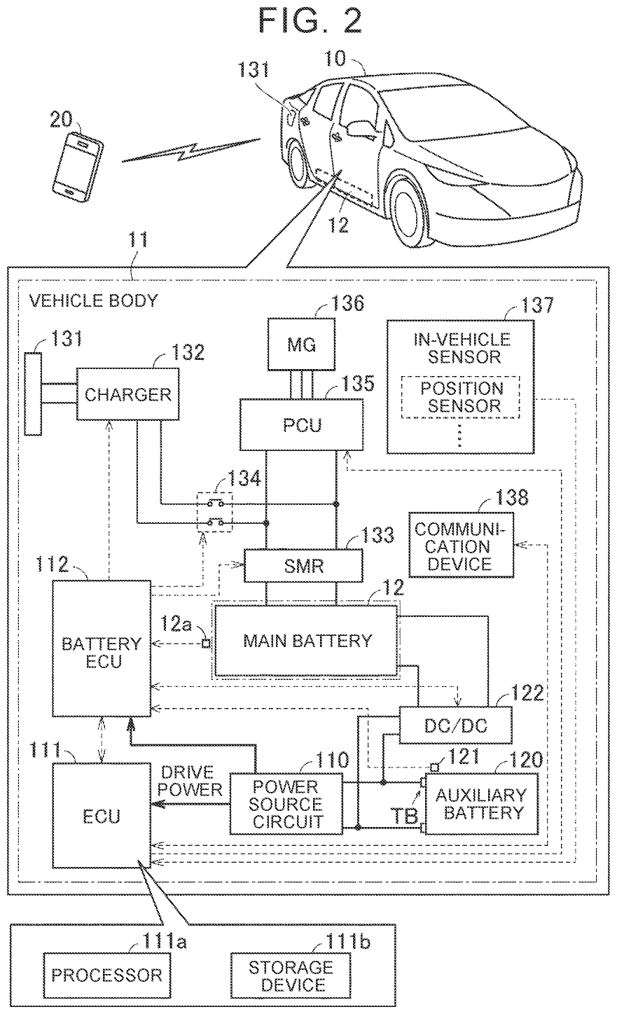

In this embodiment, when a clerk at the dealer 100 sells or leases the vehicle 10, identification information (vehicle ID) on the vehicle 10, vehicle type information, and contract information are written into each of a storage device (not illustrated) of the server 150 and a storage device (e.g. a storage device 111b illustrated in FIG. 2 to be discussed later) of the vehicle 10. The server 150 also transmits such information to the management center 500, and the management center 500 saves such information in the storage device 520. The vehicle ID may be a vehicle identification number (VIN).

The vehicle type information indicates the type and the specifications of the vehicle 10. The vehicle type information may indicate which of battery electric vehicles (BEVs), plug-in hybrid electric vehicles (PHEVs), hybrid electric vehicles (HEVs), and fuel cell electric vehicles (FCEVs) the vehicle 10 belongs to, for example. The vehicle type information may indicate the dimensions and the equipment of the vehicle 10. The vehicle type information may indicate the power source and the travel performance of the vehicle 10. The vehicle type information may indicate the specifications (e.g. capacity and maximum output) of the power storage device, and may indicate the specifications of components mounted on the vehicle 10 other than the power storage device.

The contract information includes the date and time of the contract, the type of the contact (e.g. partial leasing/entire leasing/sales), and price information (e.g. lease fee or sales price). The contact information for a lease contract further includes a lease period.

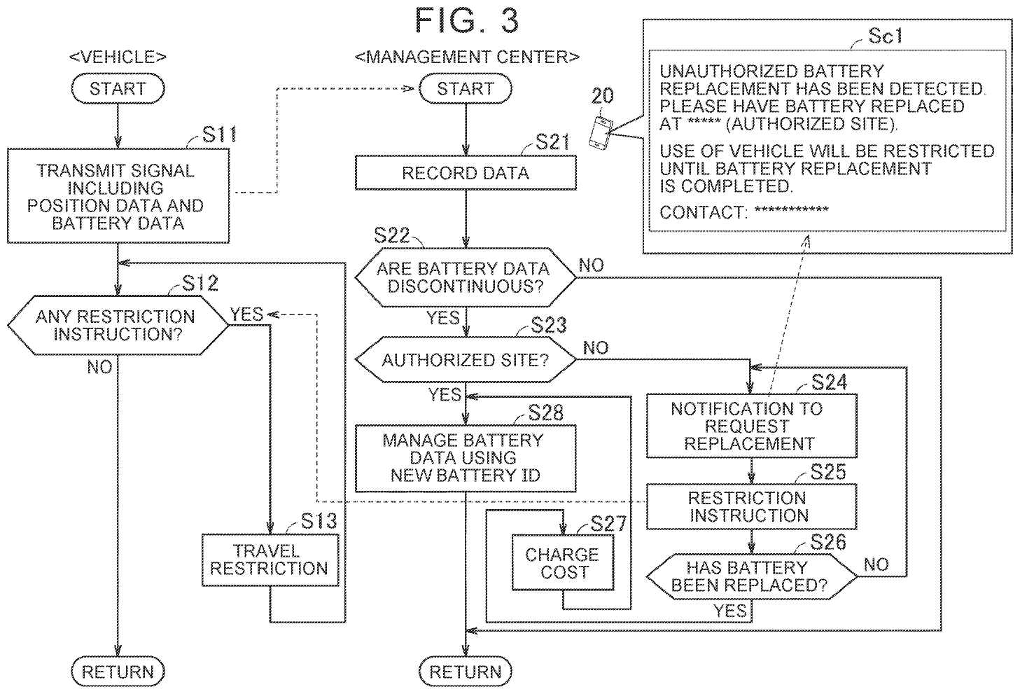

The management center 500 assigns identification information (battery ID) to the power storage device mounted on the vehicle 10, and manages data (battery data) about the power storage device measured on the vehicle 10 in connection with the battery ID. When the power storage device mounted on the vehicle 10 has been replaced, the management center 500 assigns new identification information (battery ID) to the power storage device attached to the vehicle 10 as a result of the replacement (see FIG. 3 to be discussed later).

In this embodiment, a plurality of dealers 100 and a plurality of BSta 200 are provided so as to cover the entire area to be covered by the vehicle management system. The BSta 200 are configured to replace a power storage device for a vehicle. The power storage device leased by the automobile manufacturer to a vehicle user is returned from the vehicle user to the dealer 100 or the BSta 200. When the battery replacement site is one of the dealers 100, the battery is replaced by a service person. When the battery replacement site is one of the BSta 200, the battery is replaced fully automatically. In this embodiment, a secondary battery is used as the power storage device. However, the power storage device may be any device that can reserve power.

In this embodiment, each of the dealers 100 and the BSta 200 corresponds to an authorized site related to replacement of the power storage device. Replacement performed at any of the dealers 100 or any of the BSta 200 is considered as authorized replacement. On the other hand, replacement performed at a site other than any of the dealers 100 and the BSta 200 is considered as unauthorized replacement. In this embodiment, replacement of the power storage device performed at a site other than the authorized sites is prohibited for not only leased vehicles (vehicles A and B) but also sold vehicles (vehicle C), so that the vehicles can operate normally or the automobile manufacturer can appropriately provide after-sales services (such as maintenance) for the vehicles. However, this is not limiting, and the management center 500 may not monitor the power storage device mounted on the sold vehicle and allow the power storage device to be replaced freely on the responsibility of the user. The management center 500 may prohibit replacement of the power storage device at a site other than the authorized sites for only the leased vehicles (vehicles A and B). The authorized sites are not limited to the dealers and the battery replacement stations, and are changeable as appropriate.

In the following description, the vehicle provided by the dealer 100 is occasionally referred to as a “vehicle 10”. The vehicle 10 according to this embodiment is any of the vehicles A, B, and C illustrated in FIG. 1. FIG. 2 is a diagram illustrating the configuration of the vehicle 10.

With reference to FIG. 2, the vehicle 10 includes a vehicle body 11 and a battery 12 (main battery) mounted on the vehicle body 11. The battery 12 corresponds to the power storage device for travel of the vehicle 10. The vehicle 10 is configured to be able to travel using power output from the battery 12. The vehicle 10 is a battery electric vehicle (BEV) that does not include an internal combustion engine, for example. A known vehicle power storage device (e.g. a liquid secondary battery or an all-solid-state secondary battery) can be used as the battery 12. Examples of the secondary battery for vehicles include a lithium-ion battery and a nickel metal hydride battery. A plurality of secondary batteries may form an assembled battery.

The vehicle body 11 includes a battery management system (BMS) 12a, a power source circuit 110, an electronic control unit (ECU) 111, a battery ECU 112, an auxiliary battery 120, a BMS 121, a direct current (DC)/DC converter 122, an inlet 131, a charger 132, a system main relay (SMR) 133, a charge relay 134, a power control unit (PCU) 135, a motor generator (MG) 136, an in-vehicle sensor 137, and a communication device 138. The vehicle body 11 further includes a human machine interface (HMI) (not illustrated). The HMI includes an input device and a display device. The HMI may include a touch panel display. The vehicle body 11 may further include an air conditioning device (not illustrated) that conditions air inside the vehicle 10 using power from the battery 12. The air conditioning device conditions (e.g. heats) air in the vehicle cabin in accordance with an instruction from the user, for example. The ECU means an electronic control unit. In this embodiment, the ECU 111 corresponds to an example of the “control device” according to the present disclosure.

The ECU 111 is a computer that includes a processor 111a and a storage device 111b. The storage device 111b stores programs to be executed by the processor 111a and information (e.g. maps, mathematical expressions, and various parameters) to be used by the programs. The storage device 111b further stores various kinds of information about the vehicle 10. Such information is updated in accordance with the status of the vehicle 10. While FIG. 2 does not illustrate the configuration of the battery ECU 112, the battery ECU 112 is also a computer that is similar in hardware configuration to the ECU 111. The ECU 111 and the battery ECU 112 are configured to be communicable with each other. These ECUs are connected through a controller area network (CAN), for example.

The communication device 138 includes a communication interface for communication with devices (e.g. the management center 500 and a portable terminal 20) outside the vehicle. The ECU 111 communicates with external devices through the communication device 138. The communication device 138 includes a communication interface for accessing the communication network NW through wireless communication. The communication device 138 may include a telematics control unit (TCU) and/or a data communication module (DCM) for wireless communication. In this embodiment, the vehicle 10 and the management center 500 are configured to be communicable with each other through wireless communication. Further, the communication device 138 may further include a communication interface for wired communication with electric vehicle supply equipment (EVSE).

The vehicle 10 is configured to enable external charge (charge of the battery 12 with power from the outside of the vehicle). The inlet 131 is configured to be removably connectable to a plug (e.g. a connector of a charge cable) of the EVSE. When the plug of the EVSE is mounted to the inlet 131 of the vehicle 10 in a parked state, the vehicle 10 is electrically connected to the EVSE (plug-in state). On the other hand, while the vehicle 10 is traveling, for example, the vehicle 10 is not electrically connected to the EVSE (plug-out state). The in-vehicle sensor 137 includes a connection detection circuit that detects the state (plug-in state/plug-out state) of the inlet 131.

In the plug-in state, the ECU 111 brings the SMR 133 and the charge relay 134 into a closed state (connected state) to execute external charge of the battery 12. The battery ECU 112 may control the charger 132 in accordance with an instruction from the ECU 111. Power input from the EVSE outside the vehicle to the inlet 131 is supplied to the charger 132. The charger 132 generates charge power in accordance with an instruction from the battery ECU 112 using power supplied from the inlet 131, and outputs the generated charge power to the battery 12. The charger 132 includes a power conversion circuit (e.g. at least one of a DC/DC conversion circuit and an alternating current (AC)/DC conversion circuit) for external charge, and generates charge power using the circuit.

The charge relay 134 switches to connect and disconnect a charge line. In the example illustrated in FIG. 2, a charge line including the inlet 131, the charger 132, and the charge relay 134 is connected between the SMR 133 and the PCU 135. However, this is not limiting, and a charge line may be connected between the battery 12 and the SMR 133. In addition, the configuration illustrated in FIG. 2 may be changed so as to enable external power supply (power supply from the battery 12 to the outside of the vehicle). For example, the charger 132 illustrated in FIG. 2 may be changed to a charger/discharger.

The PCU 135 drives the MG 136 using power output from the battery 12. The PCU 135 includes an inverter and a DC/DC converter, for example. The PCU 135 is controlled by the ECU 111. The MG 136 functions as a travel motor of the vehicle 10. The MG 136 is driven by the PCU 135, and rotates drive wheels of the vehicle 10. The MG 136 also regenerates power during deceleration of the vehicle 10, for example, and outputs generated power to the battery 12. The vehicle 10 may include any number of travel motors.

The in-vehicle sensor 137 includes a position sensor, a vehicle speed sensor, an accelerator sensor, a brake sensor, an outside temperature sensor, and an inside temperature sensor, and consecutively outputs detection results of the sensors to the ECU 111. The position sensor may be a sensor that detects the position (e.g. longitude and latitude) of the vehicle 10 using a position measurement system such as a global positioning system (GPS), for example. The position sensor may be included in a car navigation system (not illustrated). The vehicle speed sensor may be provided on each wheel (or a rotary shaft of each wheel) provided in the vehicle 10. The accelerator sensor is provided on an accelerator operation portion (not illustrated) such as an accelerator pedal, for example, and detects an accelerator operation amount. The brake sensor is provided on a brake operation portion (not illustrated) such as a brake pedal, for example, and detects a brake operation amount. The outside temperature sensor detects a temperature (outside temperature) around the vehicle 10. The inside temperature sensor detects a temperature in the vehicle 10 (e.g. the temperature in the vehicle cabin).

The battery 12 is provided with the BMS 12a. The BMS 12a includes various sensors (e.g. a current sensor, a voltage sensor, and a temperature sensor) that detect the state of the battery 12, and consecutively outputs detection results of the sensors to the battery ECU 112. The battery ECU 112 acquires battery data that indicate the state (e.g. temperature, current, voltage, and state of charge (SOC)) of the battery 12 based on the output of the BMS 12a, and outputs the obtained battery data to the ECU 111. During external charge of the battery 12, the battery ECU 112 controls the charger 132 while confirming the state of the battery 12 being charged based on the output of the BMS 12a. The state of charge (SOC) indicates the remaining amount of stored power, and represents the proportion of the present amount of stored power to the amount of stored power in the fully charged state in 0 to 100%, for example. The SOC may be measured using a known method, and at least one of a current integration method, an open circuit voltage (OCV) estimation method, an equivalent circuit model method, and a non-linear Kalman filter method may be used, for example.

A control system (including the ECU 111 and the battery ECU 112) of the vehicle 10 is supplied with power from the auxiliary battery 120. A wire from an in-vehicle circuit (including the power source circuit 110) is connected (using e.g. a bolt or a connector) to a terminal TB of the auxiliary battery 120. The auxiliary battery 120 supplies power to the power source circuit 110. The auxiliary battery 120 is electrically connected to each of the ECU 111 and the battery ECU 112 via the power source circuit 110. The power source circuit 110 corresponds to the power source circuit for these ECUs. The power source circuit 110 converts power input from the auxiliary battery 120 into power that is suitable to drive the ECUs, and outputs drive power to the ECUs.

The battery 12 is configured to be able to supply power to the auxiliary battery 120. The battery 12 supplies power to the auxiliary battery 120 via the DC/DC converter 122. The auxiliary battery 120 is provided with the BMS 121. The BMS 121 includes various sensors that detect the state of the auxiliary battery 120, and consecutively outputs detection results of the sensors to the battery ECU 112. The battery ECU 112 acquires the state (e.g. temperature, current, voltage, and SOC) of the auxiliary battery 120 based on the output of the BMS 121, and controls the DC/DC converter 122 based on the obtained state of the auxiliary battery 120. When the SOC of the auxiliary battery 120 falls below a first lower limit value, the battery ECU 112 controls the DC/DC converter 122 such that the auxiliary battery 120 is charged with power from the battery 12. During charge control for the auxiliary battery 120, the DC/DC converter 122 converts (e.g. transforms) power input from the battery 12 to power that is suitable to charge the auxiliary battery 120, and outputs the power after the conversion to the auxiliary battery 120. When the SOC of the auxiliary battery 120 becomes equal to or more than a second lower limit value that is greater than the first lower limit value, the battery ECU 112 controls the DC/DC converter 122 such that power supply from the battery 12 to the auxiliary battery 120 is stopped.

In the vehicle 10, the ECU 111 performs integral control for the entire vehicle. The ECU 111 acquires detection results from the various sensors (including the BMS 12a and the in-vehicle sensor 137) mounted on the vehicle 10. The ECU 111 also acquires information from each of the battery ECU 112 and the communication device 138. The vehicle information acquired by the ECU 111 is saved in the storage device 111b. The vehicle 10 transmits the latest vehicle information to the management center 500 together with the vehicle ID of the vehicle 10 in response to a request from the management center 500.

The portable terminal 20 is configured to be carried by a user. The portable terminal 20 is carried and operated by a user (vehicle manager) of the vehicle 10. In this embodiment, a smartphone equipped with a touch panel display is used as the portable terminal 20. The smartphone includes a built-in computer, and has a speaker function. However, this is not limiting, and examples of the portable terminal 20 include a laptop computer, a tablet terminal, a portable gaming device, a wearable device (such as a smartwatch, smartglasses, and smartgloves), an electronic key, etc.

Application software (hereinafter referred to as a “mobile app”) for using a service provided by the management center 500 is installed in the portable terminal 20. The mobile app allows identification information (terminal ID) on the portable terminal 20 to be registered in the management center 500 in connection with identification information (vehicle ID) on the corresponding vehicle 10. The portable terminal 20 can exchange information with each of the management center 500, the server 250, and the server 150 through the mobile app.

FIG. 3 is a flowchart illustrating a vehicle management method according to this embodiment. The symbol “S” in the flowchart means a step. The ECU 111 starts a series of processes in S11 to S13 indicated in FIG. 3 when the ECU 111 is started in response to a request from the user or upon power restoration, for example. After that, the ECU 111 repeatedly executes the series of processes in S11 to S13 as described below.

With reference to FIG. 3 together with FIGS. 1 and 2, in S11, the ECU 111 measures data (battery data) about the battery 12 and the position of the vehicle 10, and transmits the measurement result and the measurement time to the management center 500 together with identification information (vehicle ID) on the vehicle 10. Specifically, the ECU 111 transmits a signal (hereinafter referred to as a “vehicle data signal”) that includes battery data that indicate the present state (e.g. temperature, current, voltage, and SOC) of the battery 12 acquired from the battery ECU 112, position data that indicate the present position of the vehicle 10 detected by a position sensor included in the in-vehicle sensor 137, and the present time corresponding to the measurement time to the management center 500 together with the vehicle ID.

Subsequently, in S12, the ECU 111 determines whether a restriction instruction (see S25 to be discussed later) has been received from the management center 500. If the battery 12 has not been replaced in the vehicle 10, the management center 500 does not issue a restriction instruction, and therefore the result of the determination made in S12 is NO, and the process returns to the initial step (S11). S11 and S12 are repeatedly performed while the battery 12 is continuously used in the vehicle 10 without being replaced.

When the vehicle data signal (S11) is received, the management center 500 starts a series of processes in S21 to S28. In S21, the management center 500 saves the various data included in the vehicle data signal (including the battery data, the position data, and the measurement time discussed above) in the storage device 520 in connection with the received vehicle ID.

Subsequently, in S22, the management center 500 determines whether the battery data recorded in S21 have become discontinuous. When data are continuous, it is meant that the value of the data is not varied but maintained even if the time elapses, or that the value of the data is continuously varied as the time elapses. When data are discontinuous, it is meant that the value of the data exhibits a variation that is not continuous at a certain time (e.g. the value of the data is abruptly varied at a certain time).

It is considered that the battery data recorded in S21 are continuous if the power storage device (battery 12) provided in the vehicle 10 is not replaced. In this case, the result of the determination made in S22 is NO, and the process returns to the initial step (S21). The process in S21 is repeatedly executed during a period for which the battery 12 is continuously used in the vehicle 10 without being replaced. The process in S11 discussed carlier is also repeatedly executed during this period. Therefore, data that indicate transitions in the position and the state of the vehicle 10 (e.g. the temperature, current, voltage, and SOC of the battery 12) are recorded in the storage device 520 through the process in S21.

In S22, it is determined whether the battery data have become discontinuous because of replacement of the battery 12. For example the management center 500 determines in S22 that the battery data have become discontinuous because of replacement of the battery 12 when a plurality of data among data on the temperature, current, voltage, and SOC of the battery 12 recorded in S21 has become discontinuous at the same time (e.g. when the values of the data are varied by an amount exceeding a predetermined amount at the same time). By such a method, battery replacement can be detected with high precision.

When the power storage device (battery 12) provided in the vehicle 10 is replaced, the power storage device to be measured in S11 is changed, and therefore the battery data recorded in S21 become discontinuous. In this case, the result of the determination made in S22 is YES, and the process proceeds to S23. The management center 500 determines that the power storage device has been replaced at the time when the battery data have become discontinuous. In the following description, the battery 12 provided in the vehicle 10 before replacement will be referred to as a “battery B1”, and the battery 12 attached to the vehicle 10 through the battery replacement will be referred to as a “battery B2”.

In S23, the management center 500 determines whether the position of the vehicle 10 at the time when the battery data have become discontinuous is an authorized site determined in advance. The time when the battery data have become discontinuous corresponds to the time when the battery 12 has been replaced in the vehicle 10. That is, the management center 500 determines in S23 whether the battery replacement has been performed at an authorized site. In this embodiment, each of the dealers 100 and the BSta 200 corresponds to an authorized site.

When it is determined that the position of the vehicle 10 at the time when the battery data have become discontinuous is an authorized site (YES in S23), that is, when the battery replacement has been performed at an authorized site, the process proceeds to S28. In S28, the management center 500 assigns new identification information (battery ID) to the battery B2, and secures a data saving region for the battery B2 in the storage device 520. After that, the process returns to the initial step (S21). The management center 500 saves battery data about the battery B2 acquired subsequently in the storage device 520 in connection with the battery ID. This allows the management center 500 to manage the battery data about the battery B2 separately from the battery data about the battery B1.

When it is determined that the position of the vehicle 10 at the time when the battery data have become discontinuous is not an authorized site (NO in S23), that is, when the battery replacement has been performed at a site other than the authorized sites, the process proceeds to S24. In S24, the management center 500 provides a user terminal (e.g. the portable terminal 20) for the vehicle 10 with a notification (hereinafter also referred to as a “replacement request notification”) that requests battery replacement. The management center 500 may specify a replacement site in the replacement request notification. In this embodiment, an authorized site that is the closest to the position of the vehicle 10, among the authorized sites at which battery replacement can be performed for the vehicle 10, is specified as the replacement site. In addition, the management center 500 may indicate the contact of a person in charge in the replacement request notification.

When a replacement request notification is received from the management center 500, the portable terminal 20 displays a screen Sc1, for example. The screen Sc1 displays a message that informs the vehicle user that unauthorized battery replacement has been detected, a message that requests the vehicle user for battery replacement, a message that informs the vehicle user that use of the vehicle 10 will be restricted until battery replacement is completed, and the contact (e.g. a telephone number or an electronic mail address) of a person in charge. However, this is not limiting, and an in-vehicle HMI may display the screen Sc1 in place of the portable terminal 20. The car navigation system of the vehicle 10 may guide the user to the specified replacement site.

Subsequently, in S25, the management center 500 transmits a signal (hereinafter referred to as a “restriction instruction”) for restricting use of the vehicle 10 to the vehicle 10. In this embodiment, a signal that restricts electric travel of the vehicle 10 in which the battery B2 is used is transmitted to the vehicle 10 as the restriction instruction. After that, in S26, the management center 500 determines whether the battery B2 has been replaced in the vehicle 10. The battery B2 in S26 corresponds to an unauthorized power storage device attached to the vehicle 10 through unauthorized replacement. The management center 500 may determine whether the battery B2 has been replaced in the vehicle 10 based on whether a replacement completion signal has been received from a terminal (e.g. the server 150 or 250) installed at the replacement site specified by the replacement request notification. S24 to S26 are repeatedly performed while the battery B2 is not replaced (NO in S26).

When the vehicle 10 receives a restriction instruction from the management center 500, the result of the determination made in S12 is YES, and the process proceeds to S13. In S13, travel control for the vehicle 10 by the ECU 111 is restricted in accordance with the restriction instruction from the management center 500. For example, output power of the battery B2 may be restricted in accordance with the restriction instruction from the management center 500. Maximum output power of the battery B2 being subjected to output restriction is smaller than that of the battery B2 not being subjected to output restriction. Alternatively, at least one of the vehicle speed of the vehicle 10, output torque of the MG 136, and the rotational speed of the MG 136 may be restricted in accordance with the restriction instruction from the management center 500. Travel restriction (S13) on the vehicle 10 is continuously performed while the vehicle 10 is receiving a restriction instruction from the management center 500.

When the user drives the vehicle 10 to the specified replacement site (authorized site) and has the battery B2 replaced at the replacement site, a replacement completion signal is transmitted to the management center 500. A replacement completion signal may be transmitted from the server 150 to the management center 500 when a clerk at the dealer 100 operates the server 150 after battery replacement is performed. Alternatively, a replacement completion signal may be transmitted to the management center 500 when the server 250 detects that battery replacement has been completed by the BSta 200. When the management center 500 receives a replacement completion signal (YES in S26), the process proceeds to S27. Consequently, the restriction instruction (S25) is not transmitted any more. In this case, the management center 500 determines that a different battery 12 has been attached to the vehicle 10 through authorized replacement after the battery B2 (unauthorized power storage device) attached to the vehicle 10 through unauthorized replacement is removed from the vehicle 10. Hereinafter, the battery 12 currently attached to the vehicle 10 will be referred to as a “battery B3”.

In S27, the user of the vehicle 10 is charged the cost for the replacement of the unauthorized power storage device. Specifically, the management center 500 provides a user terminal (e.g. the portable terminal 20) for the vehicle 10 with a notification (hereinafter also referred to as a “cost charge notification”) that charges the cost for the battery replacement. The cost for the battery replacement may include at least one of the cost for preparing a replacement battery (battery B3) and the labor cost for the battery replacement. The management center 500 may also request the vehicle user to return or compensate the battery B1.

Subsequently, in S28, the management center 500 assigns new identification information (battery ID) to the battery B3, and secures a data saving region for the battery B3 in the storage device 520. After that, the process returns to the initial step (S21).

When replacement of the battery B2 with the battery B3 is completed in the vehicle 10, the vehicle 10 does not receive the restriction instruction (S25) from the management center 500 any more, and the result of the determination made in S12 is NO. Consequently, travel restriction (S13) on the vehicle 10 is canceled. Then, the process in S11 is executed for the battery B3.

As has been described above, the vehicle management method according to this embodiment includes the processes illustrated in FIG. 3. In this embodiment, the management center 500 and the ECU 111 function as an example of the “computer system” according to the present disclosure. The processes are executed by one or more processors executing a program stored in one or more storage devices. However, the processes may be executed by dedicated hardware (electronic circuitry), rather than by software.

The vehicle management method according to this embodiment includes: determining whether the power storage device (battery 12) provided in the vehicle 10 has been replaced (S21, S22); and determining whether the replacement of the power storage device has been performed in an unauthorized manner when it is determined that the power storage device has been replaced. The determining as to whether the replacement has been performed in an unauthorized manner includes determining whether the replacement has been performed at an authorized site (S23). With such a method, it is possible to adequately confirm whether the power storage device mounted on the vehicle 10 has been replaced in an unauthorized manner based on whether the replacement of the power storage device has been performed at an authorized site.

In the vehicle management method according to this embodiment, the determining as to whether the power storage device has been replaced includes acquiring data about the power storage device measured in the vehicle 10 (S21) and determining whether the power storage device has been replaced based on whether the data have become discontinuous (S22). The determining as to whether the replacement has been performed in an unauthorized manner includes determining whether the replacement has been performed in an authorized manner based on whether the position of the vehicle at the time when the data have become discontinuous is an authorized site (S23). With such a method, it is easy to adequately determine whether the power storage device has been replaced based on whether the data about the power storage device in the vehicle 10 have become discontinuous. With the above method, further, it is easy to adequately determine whether the replacement has been performed in an authorized manner based on whether the position of the vehicle at the time when the data have become discontinuous is an authorized site.

The vehicle management method according to this embodiment further includes executing processes of making a notification that unauthorized replacement has been performed (S24) when it is determined that the replacement has been performed in an unauthorized manner and restricting use of the vehicle 10 (S25) when it is determined that the replacement has been performed in an unauthorized manner. With such a method, it is possible to suppress continued use of the vehicle 10 to which an unauthorized power storage device has been attached when replacement of the power storage device has been performed in an unauthorized manner.

The vehicle management method according to this embodiment further includes notifying the user of the vehicle 10 to suggest replacing the unauthorized power storage device attached to the vehicle 10 through the unauthorized replacement (S24) and charging the user of the vehicle 10 the cost for the replacement of the unauthorized power storage device (S27) when it is determined that the replacement has been performed in an unauthorized manner. With such a method, the vehicle user that has performed the unauthorized replacement is charged the cost for the replacement of the unauthorized power storage device. Consequently, unauthorized replacement can be suppressed.

The process flow illustrated in FIG. 3 is changeable as appropriate. For example, the order of the processes may be changed, and unnecessary steps may be omitted, depending on the purpose. In addition, the content of any of the processes may be changed.

In the above embodiment, the management center 500 determines in S22 that the battery data have become discontinuous because of replacement of the battery 12 when two or more of the plurality of types of battery data recorded in S21 in FIG. 3 (e.g. two or more of temperature data, current data, voltage data, and SOC data) are discontinuous at the same time. However, this is not limiting, and the management center 500 may determine that the battery data have become discontinuous because of replacement of the battery 12 when all of the recorded battery data (e.g. all of temperature data, current data, voltage data, and SOC data) are discontinuous at the same time. Alternatively, the management center 500 may determine whether the battery data have become discontinuous because of replacement of the battery 12 based on only SOC data (remaining stored power amount data) that indicate transitions in the remaining stored power amount of the power storage device.

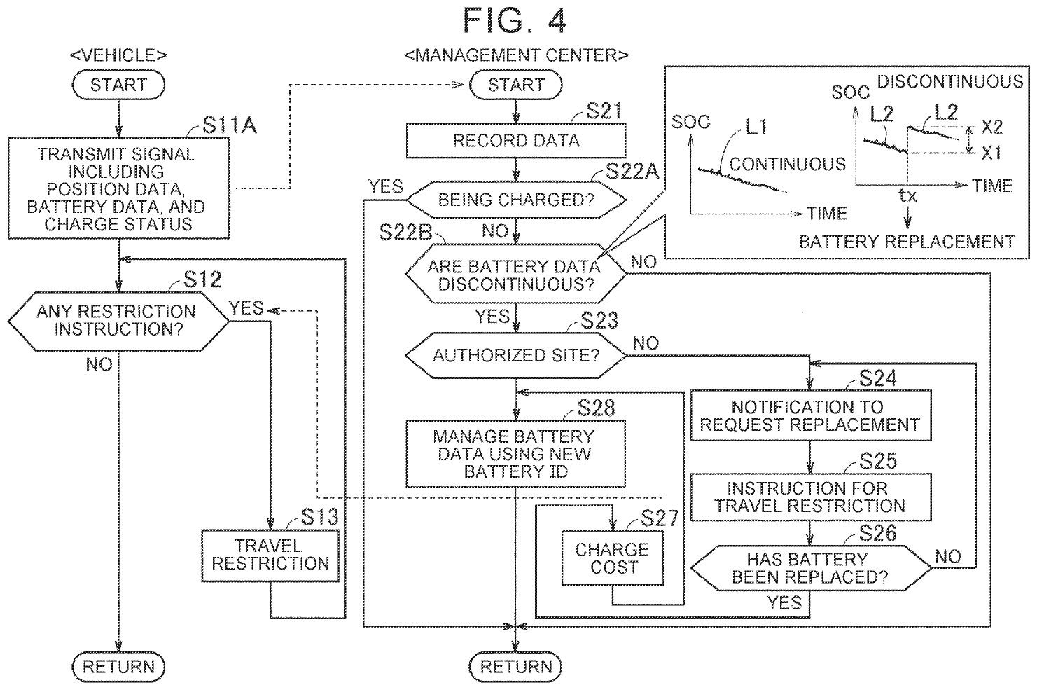

FIG. 4 is a flowchart illustrating a first modification of the process illustrated in FIG. 3. With reference to FIG. 4, in this modification, S11A is used in place of S11 (FIG. 3). Also in S11A, as in S11 in FIG. 3, a vehicle data signal is transmitted to the management center 500 together with identification information (vehicle ID) on the vehicle 10. However, the vehicle data signal in S11A further includes a charge status that indicates whether the battery 12 is being charged, in addition to the SOC data that indicate the present remaining stored power amount of the battery 12, the position data that indicate the present position of the vehicle 10, and the present time corresponding to the measurement time.

The ECU 111 determines whether the battery 12 is being charged based on the battery data acquired from the battery ECU 112 and the state of the vehicle 10 (including the vehicle speed, the accelerator operation amount, the brake operation amount, and the state of the inlet 131) detected by the in-vehicle sensor 137, for example. In this embodiment, the ECU 111 determines that the battery 12 is being charged when either of external charge and regenerative charge is executed for the battery 12. On the other hand, the ECU 111 determines that the battery 12 is not being charged when neither charge is executed for the battery 12. Then, the ECU 111 generates a charge status that indicates the above determination result, and saves the generated charge status in the storage device 111b and transmits the charge status to the management center 500.

In this modification, S22A and S22B are used in place of S22 (FIG. 3). In S21, the management center 500 saves the various data included in the vehicle data signal (S11A) (including the SOC data, the position data, the charge status, and the measurement time discussed above) in the storage device 520 in connection with the received vehicle ID. Subsequently, in S22A, the management center 500 determines based on the charge status included in the vehicle data signal whether the battery 12 is being charged in the vehicle 10. When the battery 12 is being charged (YES in S22A), the process returns to the initial step (S21). When the battery 12 is not being charged (NO in S22A), on the other hand, the process proceeds to S22B. In S22B, it is determined whether the SOC data (remaining stored power amount data) included in the vehicle data signal include a time when the remaining stored power amount of the battery 12 is increased by a predetermined amount or more. The predetermined amount corresponds to a threshold for detecting replacement of the battery 12.

It is considered that the battery data recorded in S21 are continuous if the power storage device (battery 12) provided in the vehicle 10 is not replaced. In this case, the result of the determination made in S22B is NO, and the process returns to S21. During a period for which the battery 12 is continuously used in the vehicle 10 without being replaced, data that indicate transitions in the position of the vehicle 10 and the SOC of the battery 12 are recorded in the storage device 520 through the process in S21. A line L1 in FIG. 4 indicates an example of continuous SOC data.

When the power storage device (battery 12) provided in the vehicle 10 is replaced, the power storage device to be measured in S11A is changed, and therefore the battery data recorded in S21 become discontinuous. In particular, it is considered that the remaining stored power amount of the battery 12 is significantly increased when the battery 12 is not being charged, only in the event that the battery 12 is replaced. A line L2 in FIG. 4 indicates an example of SOC data in which the value of the data becomes discontinuous at time tx because of replacement of the battery 12 while the battery 12 is not being charged. Specifically, the value of the data rises from X1 to X2 at time tx when the battery 12 is not being charged. The amount of rise (=X2−X1) at time tx is a predetermined amount or more. Time tx corresponds to a time when the battery 12 is not being charged and the remaining stored power amount of the battery 12 has increased by a predetermined amount or more. When the SOC data included in the vehicle data signal include time tx, the result of the determination made in S22B is YES, and the process proceeds to S23. The management center 500 determines that the battery 12 has been replaced at time tx. It is easy to adequately determine whether the battery 12 has been replaced by determining whether the remaining stored power amount data on the battery 12 have become discontinuous because of battery replacement based on whether the remaining stored power amount data include a time when the remaining stored power amount is increased by a predetermined amount or more while the battery 12 is not being charged as described above.

The vehicle 10 may be an electrified vehicle (xEV) other than BEVs. For example, the vehicle 10 may be a plug-in hybrid electric vehicle (PHEV) that further includes an internal combustion engine as a power source in addition to the components illustrated in FIG. 2.

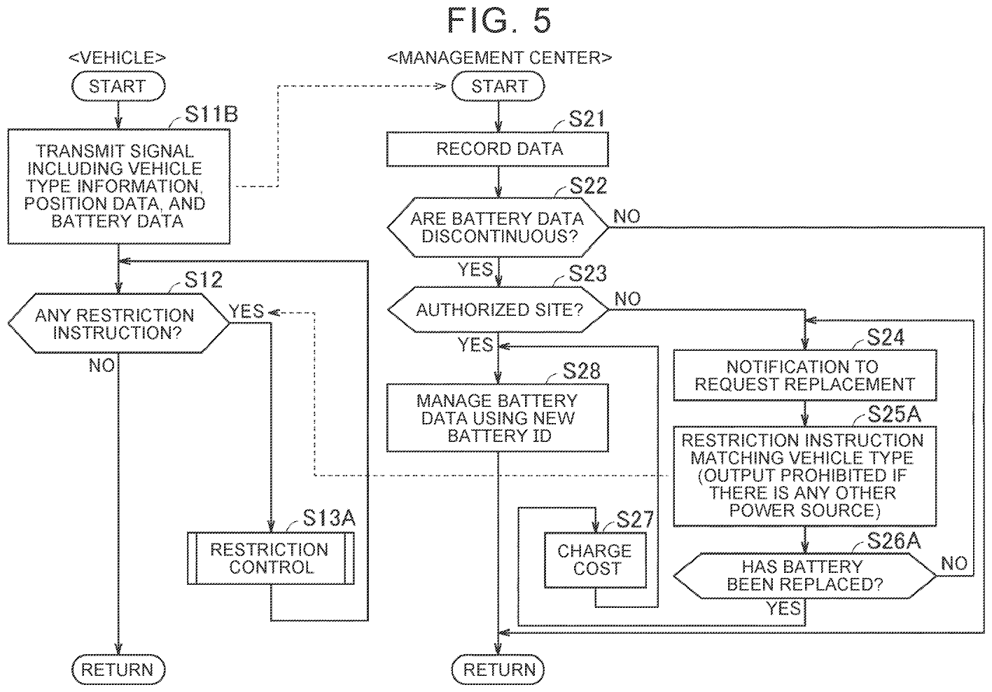

FIG. 5 is a flowchart illustrating a second modification of the process illustrated in FIG. 3. With reference to FIG. 5, in this modification, S11B and S13A are used in place of S11 and S13 (FIG. 3), respectively. Also in S11B, as in S11 in FIG. 3, a vehicle data signal is transmitted to the management center 500 together with identification information (vehicle ID) on the vehicle 10. However, the vehicle data signal in S11B further includes vehicle type information, in addition to the battery data that indicate the present state of the battery 12, the position data that indicate the present position of the vehicle 10, and the present time corresponding to the measurement time. The vehicle type information indicates the specifications of the vehicle 10.

In this modification, S25A and S26A are used in place of S25 and S26 (FIG. 3), respectively. That is, when it is determined that the replacement has been performed in an unauthorized manner (NO in S23), the processes in S24, S25A, and S26A are executed. In S25A, the management center 500 transmits a restriction instruction that matches the specifications of the vehicle 10 indicated by the vehicle type information to the vehicle 10. That is, the management center 500 changes the restriction instruction in accordance with the specifications of the vehicle 10. In this modification, when the vehicle 10 includes a power source (e.g. an internal combustion engine) other than the battery 12, the management center 500 transmits a restriction instruction (hereinafter referred to as a “first restriction instruction”) that prohibits output from the battery 12 to the vehicle 10. When the vehicle 10 does not include a power source other than the battery 12, the management center 500 transmits a restriction instruction (hereinafter referred to as a “second restriction instruction”) that restricts the output from the battery 12 to a degree that does not prohibit such output to the vehicle 10.

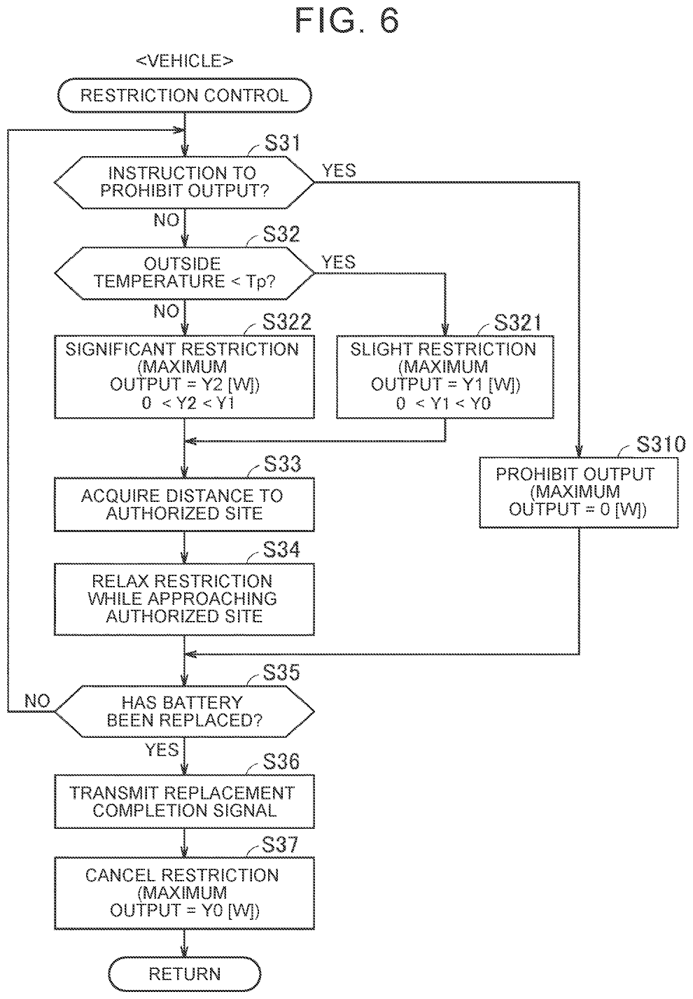

In S26A, the management center 500 determines whether a replacement completion signal (see S36 in FIG. 6) to be discussed later has been received from the vehicle 10. Before the management center 500 receives a replacement completion signal (NO in S26A), S24, S25A, and S26A are repeatedly performed, and the management center 500 transmits a restriction instruction (S25A) to the vehicle 10. When the vehicle 10 receives a restriction instruction from the management center 500, the result of the determination in S12 is YES, and the process proceeds to S13A. In S13A, the ECU 111 executes restriction control illustrated in FIG. 6 to be described below.

FIG. 6 is a flowchart illustrating the details of S13A in FIG. 5. In each of S310, S321, S322, and S34, the ECU 111 sets an upper limit value (hereinafter referred to as an “output upper limit value”) for restricting output power of the battery B2 (unauthorized power storage device) attached to the vehicle 10 through unauthorized replacement. In the example to be described below, the output upper limit value of the battery 12 at the time when output is not restricted is “Y0 (W)”. Use of an unauthorized battery can be restricted by reducing the output upper limit value of the battery B2 to be less than Y0 when replacement of the battery 12 is performed in an unauthorized manner and an unauthorized battery (battery B2) is attached to the vehicle 10.

With reference to FIG. 6, in S31, the ECU 111 determines whether the vehicle 10 has received a first restriction instruction (instruction to prohibit output). When the vehicle 10 has received a first restriction instruction (YES in S31), in S310, the ECU 111 sets the output upper limit value of the battery B2 such that output from the battery B2 is prohibited. That is, the ECU 111 sets the output upper limit value to “0 (W)”. Consequently, the maximum output of the battery B2 is brought to 0 W, and output from the battery B2 is prohibited. When the process in S310 is executed, the process proceeds to S35.

When the vehicle 10 has received a second restriction instruction (NO in S31), in S32, the ECU 111 determines whether the outside temperature of the vehicle 10 detected by the in-vehicle sensor 137 (outside temperature sensor) is lower than a predetermined value (hereinafter denoted as “Tp”). When the outside temperature of the vehicle 10 is lower than Tp (YES in S32), in S321, the ECU 111 sets the output upper limit value of the battery B2 to “Y1 (W)”. When the outside temperature of the vehicle 10 is not lower than Tp (NO in S32), on the other hand, in S322, the ECU 111 sets the output upper limit value of the battery B2 to “Y2 (W)”. Y1 is more than 0 and less than Y0. Y2 is more than 0 and less than Y1. In both S321 and S322, output from the battery 12 is restricted to a degree that does not prohibit such output. When the outside temperature of the vehicle 10 is lower than Tp, however, the ECU 111 relaxes the restriction on the output from the battery B2, compared to when the outside temperature of the vehicle 10 is higher than Tp, in order to allow power consumption due to heating. Heating in the vehicle 10 is performed by the air conditioning device that is supplied with power from the battery B2.

Subsequently, in S33, the ECU 111 acquires a distance from the present position of the vehicle 10 to the replacement site (authorized site) specified by the replacement request notification (S24). Subsequently, in S34, the ECU 111 varies the output upper limit value of the battery B2 in accordance with the distance acquired in S33. Specifically, the ECU 111 sets the output upper limit value of the battery B2 such that the output upper limit value becomes larger (the output upper limit value is brought closer to Y0) as the vehicle 10 approaches the specified replacement site. With the process in S34, the restriction on the output from the battery B2 is relaxed to a greater degree as the vehicle 10 approaches the specified replacement site. Consequently, the vehicle user is prompted to bring the vehicle 10 to the specified replacement site.

Subsequently, in S35, the ECU 111 determines whether the battery B2 has been replaced in the vehicle 10. For example, a scan tool (diagnostic machine) is connected to the vehicle 10 when the vehicle 10 arrives at the specified replacement site. When the battery B2 is replaced in the vehicle 10, a reset signal indicating that replacement of the battery B2 has been completed is input from the scan tool to the ECU 111. The ECU 111 determines based on the presence or absence of a reset signal from the scan tool whether replacement of the battery B2 has been performed in the vehicle 10. When it is determined that replacement of the battery B2 has not been performed in the vehicle 10 (NO in S35), the process returns to S31, and the processes discussed above are repeatedly performed.

When the ECU 111 receives a reset signal from the scan tool, on the other hand, the ECU 111 determines that replacement of the battery B2 has been performed in the vehicle 10 (YES in S35), and subsequently in S36, transmits a replacement completion signal to the management center 500. The replacement completion signal indicates that replacement of the battery B2 with the battery B3 has been completed in the vehicle 10. When a replacement completion signal is received from the vehicle 10 (YES in S26A in FIG. 5), the management center 500 does not transmit the restriction instruction (S25A) any more. Subsequently, in S37, the ECU 111 sets the output upper limit value of the battery B2 to “Y0 (W)”. Consequently, the restriction on the output from the battery B2 is canceled. When the process in S37 is executed, the series of processes indicated in FIG. 6 is finished, the process returns to the flowchart in FIG. 5, and the result of the determination made in S12 is NO. This allows the process in S11B to be executed for the battery B3.

In the above embodiment, the management center 500 always monitors whether the replacement of the battery 12 has been performed in an unauthorized manner in the vehicle 10 (see S11 and S21 to S23 in FIG. 3). However, this is not limiting, and the management center 500 may determine at only a predetermined timing whether the replacement of the battery 12 has been performed in an unauthorized manner in the vehicle 10.

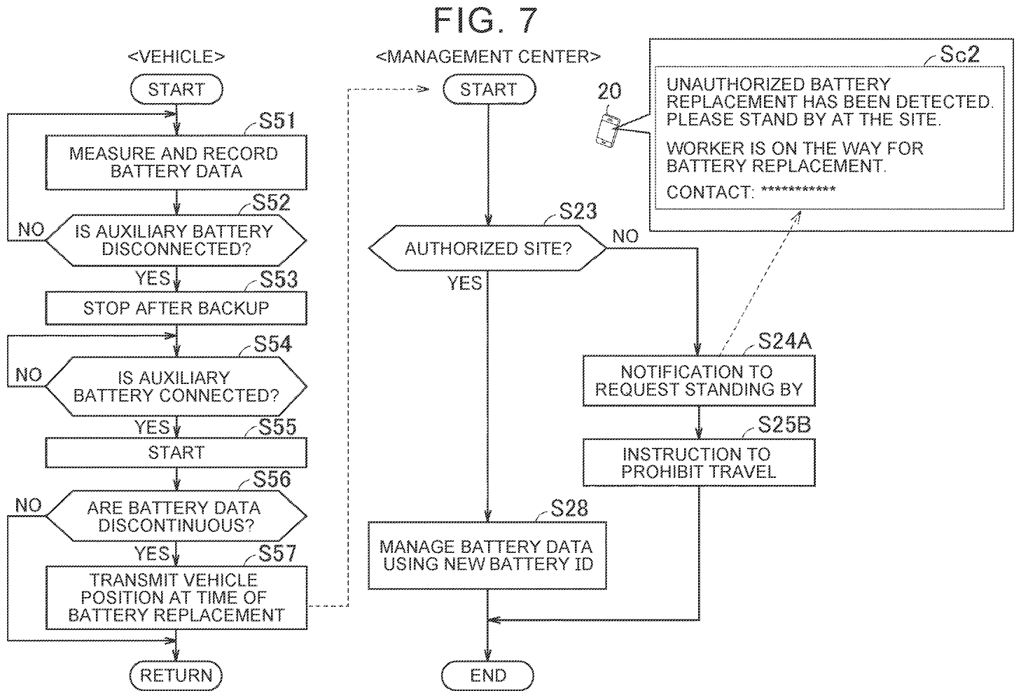

FIG. 7 is a flowchart illustrating a third modification of the process illustrated in FIG. 3. In this modification, with reference to FIG. 7, in S51, the ECU 111 records battery data that indicate the present SOC of the battery 12 acquired from the battery ECU 112 in the storage device 111b. The battery data recorded here include an SOC measurement value measured by the BMS 12a. Subsequently, in S52, the ECU 111 determines whether the auxiliary battery 120 has been disconnected from the in-vehicle circuit (including the power source circuit 110). The ECU 111 may determine based on variations in the voltage applied to the power source circuit 110 whether the auxiliary battery 120 has been disconnected from the in-vehicle circuit. Alternatively, the ECU 111 may determine based on information from the battery ECU 112 (e.g. the result of the detection by the BMS 121) whether the auxiliary battery 120 has been disconnected from the in-vehicle circuit.

S51 and S52 are repeatedly performed while the auxiliary battery 120 is connected to the in-vehicle circuit (NO in S52). When the auxiliary battery 120 is disconnected from the in-vehicle circuit (YES in S52), on the other hand, the ECU 111 is brought into a stopped state (e.g. a sleep state or a shutdown state) after performing data backup in S53. The power source circuit 110 stores power for backup when connected to the auxiliary battery 120. Therefore, the ECUs can maintain operation for a short time using power from the power source circuit 110 even when the auxiliary battery 120 is disconnected from the power source circuit 110.

After that, in S54, the ECU 111 determines whether the auxiliary battery 120 is connected again, and stands by until the auxiliary battery 120 is connected to the in-vehicle circuit again. When the auxiliary battery 120 is connected to the in-vehicle circuit again (YES in S54), the ECU 111 is started in S55. Subsequently, in S56, the ECU 111 that has been started determines whether the SOC data on the battery 12 have become discontinuous because of replacement of the battery 12 by comparing SOC data on the battery 12 recorded immediately before the start and SOC data on the battery 12 measured immediately after the start. Specifically, the ECU 111 measures the SOC (remaining stored power amount) of the battery 12 immediately after the start. The battery 12 is not being charged immediately after the start of the ECU 111. The ECU 111 determines whether the SOC data on the battery 12 have become discontinuous because of replacement of the battery 12 based on whether the remaining stored power amount (S51) of the battery 12 recorded immediately before the start of the ECU 111 has been increased by a predetermined amount or more compared to the remaining stored power amount (S56) of the battery 12 measured immediately after the start of the ECU 111.

When the SOC data on the battery 12 have become discontinuous because of replacement of the battery 12 (YES in S56), subsequently in S57, the ECU 111 transmits a signal (hereinafter referred to as a “replacement position signal”) that indicates the position of the vehicle 10 (e.g. the present position of the vehicle 10) at the time when the SOC data on the battery 12 have become discontinuous because of replacement of the battery 12 to the management center 500 together with identification information on the vehicle 10. The position of the vehicle 10 indicated by the replacement position signal corresponds to the position of the vehicle 10 at the time when the battery 12 has been replaced. When the SOC data on the battery 12 have not become discontinuous because of replacement of the battery 12 (NO in S56), on the other hand, the process returns to the initial step (S51) without executing the process in S57.

When a replacement position signal (S57) is received from the vehicle 10, in S23, the management center 500 determines whether the position of the vehicle 10 indicated by the replacement position signal is an authorized site determined in advance. When the position of the vehicle 10 indicated by the replacement position signal is an authorized site (YES in S23), in S28, the management center 500 assigns new identification information (battery ID) to the battery B2 (authorized power storage device), and secures a data saving region for the battery B2 in the storage device 520. S28 in FIG. 7 is the same as S28 in FIG. 3.

When the position of the vehicle 10 indicated by the replacement position signal is not an authorized site (NO in S23), the management center 500 determines that battery replacement has been performed in an unauthorized manner in the vehicle 10, and the process proceeds to S24A. In S24A, the management center 500 provides a user terminal (e.g. the portable terminal 20) for the vehicle 10 with a notification (hereinafter also referred to as a “standby request notification”) that requests standing by.

When a standby request notification is received from the management center 500, the portable terminal 20 displays a screen Sc2, for example. The screen Sc2 displays a message that informs the vehicle user that unauthorized battery replacement has been detected, a message that requests the vehicle user to stand by at the site, a message that informs the vehicle user that a person in charge is on the way to the position of the vehicle 10, and the contact of the person in charge. An in-vehicle HMI may display the screen Sc2 in place of the portable terminal 20.

Subsequently, in S25B, the management center 500 makes the vehicle 10 unable to travel by sending the ECU 111 an instruction that prohibits travel control for the vehicle 10. It is considered that there is no problem if the vehicle 10 is maintained in the current state (parked state) since the vehicle 10 is located at a site at which unauthorized battery replacement has been performed. The prohibition of travel control for the vehicle 10 is canceled by the person in charge after the person in charge replaces the unauthorized battery (battery B2).

The vehicle management system according to the above modification includes a vehicle 10 that includes a power storage device (battery 12) and a control device (ECU 111), and a server (management center 500) configured to be communicable with the vehicle 10. The control device is configured to measure and record data about the power storage device (see S51 in FIG. 7). The control device is configured to determine whether the data have become discontinuous because of replacement of the power storage device (sec S56 in FIG. 7). The control device is configured to transmit a signal that indicates the position of the vehicle 10 at the time when the data have become discontinuous to the server when it is determined that the data have become discontinuous (see S57 in FIG. 7). The server is configured to determine whether the position of the vehicle 10 indicated by the signal is an authorized site determined in advance (S23 in FIG. 7) when the signal is received, and restrict use of the vehicle 10 (S25B in FIG. 7) when the position of the vehicle 10 indicated by the signal is not an authorized site. With such a system, it is possible to confirm whether the power storage device mounted on the vehicle 10 has been replaced in an unauthorized manner. Then, use of the vehicle 10 can be restricted when the power storage device has been replaced in an unauthorized manner in the vehicle 10.

In the vehicle management system according to the above modification, the vehicle 10 is configured to be able to travel using power output from the battery 12 (see FIG. 2). The vehicle 10 includes an auxiliary battery 120 that supplies power to the power source circuit 110 of the ECU 111 (see FIG. 2). The battery 12 is configured to be able to supply power to the auxiliary battery 120. In the thus configured vehicle 10, there is a high possibility that the auxiliary battery 120 supplied with power from the battery 12 is disconnected from the in-vehicle circuit before the work of replacing the battery 12 (power storage device for travel) is performed. For example, a wire connecting the auxiliary battery 120 and the in-vehicle circuit and connected to the terminal TB (using e.g. a bolt or a connector) is disconnected. When the auxiliary battery 120 is disconnected from the in-vehicle circuit (including the power source circuit 110), the ECU 111 supplied with power from the auxiliary battery 120 is brought into a stopped state. After that, when replacement of the battery 12 is completed, the ECU 111 is started with the auxiliary battery 120 connected to the power source circuit 110 again.

In the vehicle 10, when the ECU 111 is brought into a stopped state with the auxiliary battery 120 disconnected from the power source circuit 110 and thereafter the ECU 111 is started with the auxiliary battery 120 connected to the power source circuit 110 again, the ECU 111 determines whether the data have become discontinuous because of replacement of the battery 12 (see S51 to S56 in FIG. 7) by comparing data recorded immediately before the start and data recorded measured immediately after the start. It is easy to determine quickly and accurately whether the battery 12 has been replaced, by determining whether the data about the battery 12 have become discontinuous because of replacement of the battery 12 at a timing when it is highly likely that replacement of the battery 12 has been performed.

The process to be executed when it is determined that battery replacement has been performed in an unauthorized manner in the vehicle 10 is not limited to the process discussed carlier (e.g. S24 to S27 indicated in FIG. 3). For example, a step of recording that unauthorized replacement has been performed may be used in addition to S24 to S27, or in place of at least one of S24 to S27, in the process indicated in FIG. 3.

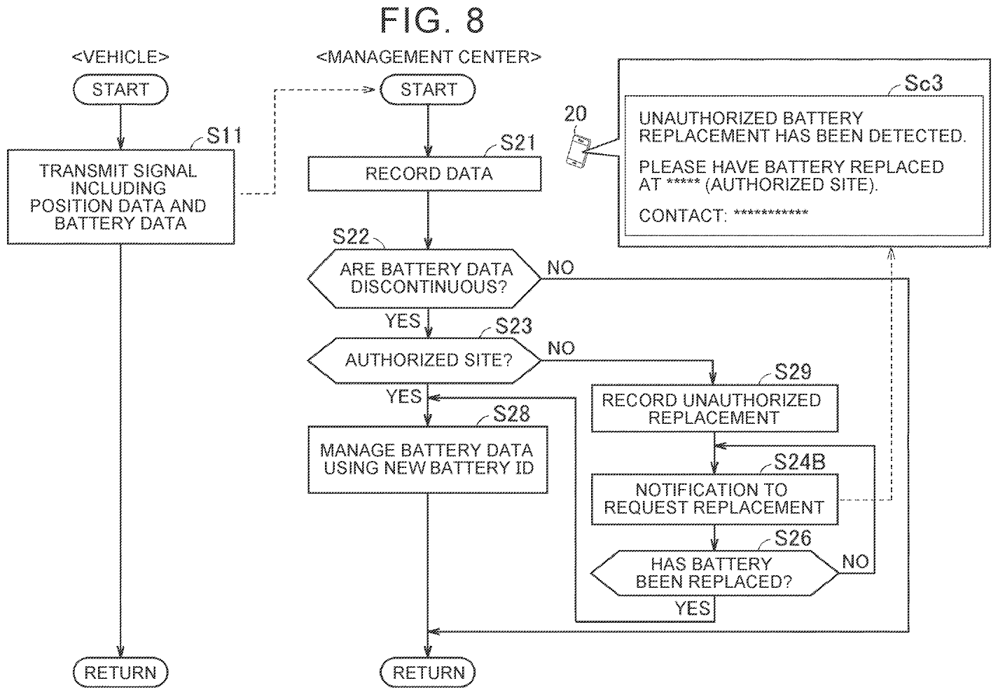

FIG. 8 is a flowchart illustrating a fourth modification of the process illustrated in FIG. 3. With reference to FIG. 8, in this modification, S12, S13, S25, and S27 (FIG. 3) are omitted, and S29 and S24B are used in place of S24. When it is determined that battery replacement has been performed in an unauthorized manner in the vehicle 10 (NO in S23), in S29, the management center 500 records that unauthorized replacement has been performed. The management center 500 saves a flag indicating that unauthorized battery replacement has been performed in the storage device 520 together with the replacement time in connection with identification information (vehicle ID) on the vehicle 10, for example. Subsequently, in S24B, the management center 500 provides a replacement request notification to a user terminal (e.g. the portable terminal 20) for the vehicle 10. When a replacement request notification is received, the portable terminal 20 displays a screen Sc3, for example. In this modification, use of the vehicle 10 is not restricted, and therefore the screen Sc3 does not include a message about restriction on use of the vehicle 10.

The functions implemented by the management center 500 in the above embodiment and various modifications may be implemented by the server 150 (dealer terminal). In this embodiment, the management center 500, the servers 150, and the servers 250 are all on-premise servers. However, this is not limiting, and the functions of the servers may be implemented on the cloud through cloud computing. That is, these servers may be cloud servers. The locations at which the lease service is provided are not limited to the dealers 100. For example, the management center 500 may provide the lease service online (e.g. on the cloud). There may be only one type of leasing method (e.g. partial leasing).

While only a battery is replaced in the above embodiment, a battery pack including a battery and auxiliary components may be replaced as a whole. The vehicle may be configured to be chargeable in a non-contact manner. The vehicle to be charged in a non-contact manner may be considered as being in a state similar to the “plug-in state” for contact charge (cable charge) discussed earlier when a power transmission portion (e.g. a power transmission coil) on the power supply equipment side and a power reception portion (e.g. a power reception coil) on the vehicle side are completely aligned with each other.

The vehicle is not limited to a four-wheeled passenger vehicle, and may be a bus, a truck, or an xEV with three or five or more wheels. The vehicle may include a solar panel. The vehicle may be configured to be capable of autonomous driving, or may be provided with a flight function. The vehicle may be a vehicle capable of unmanned travel (e.g. a robotaxi, an automated guided vehicle, or an agricultural machine).

The embodiment disclosed herein should be considered to be illustrative and not restrictive in all respects. The scope of the present disclosure is set forth by the claims rather than by the above description of the embodiment, and is intended to include all modifications within the meaning and the scope equivalent to the claims.

What is claimed is:

1. A vehicle management method comprising:
determining whether a power storage device provided in a vehicle has been replaced; and
determining whether replacement of the power storage device has been performed in an unauthorized manner when a determination that the power storage device has been replaced is made, wherein
the determining as to whether the replacement has been performed in an unauthorized manner includes determining whether the replacement has been performed at an authorized site.

2. The vehicle management method according to claim 1, wherein:
the determining as to whether the power storage device has been replaced includes acquiring data about the power storage device measured in the vehicle, and
determining whether the power storage device has been replaced based on whether the data have become discontinuous; and
the determining as to whether the replacement has been performed in an unauthorized manner includes determining whether the replacement has been performed in an authorized manner based on whether a position of the vehicle at a time when the data have become discontinuous is the authorized site.

3. The vehicle management method according to claim 2, wherein:
the data about the power storage device includes remaining stored power amount data that indicate transitions in a remaining stored power amount of the power storage device; and
the determining as to whether the power storage device has been replaced includes determining whether the remaining stored power amount data have become discontinuous based on whether the remaining stored power amount data include a time when the remaining stored power amount of the power storage device is increased by a predetermined amount or more while the power storage device is not being charged.

4. The vehicle management method according to claim 1, further comprising executing at least one of processes of recording that unauthorized replacement has been performed, making a notification that unauthorized replacement has been performed, and restricting use of the vehicle when a determination that the replacement has been performed in an unauthorized manner is made.

5. The vehicle management method according to claim 1, further comprising setting an upper limit value that restricts output power of an unauthorized power storage device attached to the vehicle through unauthorized replacement when a determination that the replacement has been performed in an unauthorized manner is made.

6. The vehicle management method according to claim 1, further comprising, when a determination that the replacement has been performed in an unauthorized manner is made, notifying a user of the vehicle to suggest replacing an unauthorized power storage device attached to the vehicle through unauthorized replacement and charging the user of the vehicle a cost for replacement of the unauthorized power storage device.

7. A computer system comprising:
one or more processors; and
one or more storage devices configured to store a program that causes the one or more processors to execute the vehicle management method according to claim 1.

8. A vehicle management system comprising:
a vehicle that includes a power storage device and an electronic control device; and
a server configured to communicate with the vehicle, wherein
the electronic control device is configured to
measure and record data about the power storage device,
determine whether the data have become discontinuous because of replacement of the power storage device, and
transmit a signal that indicates a position of the vehicle at a time when the data have become discontinuous to the server when a determination that the data have become discontinuous is made, and
the server is configured to
determine whether the position of the vehicle indicated by the signal is an authorized site determined in advance when the signal is received, and
restrict use of the vehicle when the position of the vehicle indicated by the signal is not the authorized site.

9. The vehicle management system according to claim 8, wherein:
the vehicle is configured to travel using power output from the power storage device;
the vehicle further includes an auxiliary battery that supplies power to a power source circuit of the electronic control device;
the power storage device is configured to supply power to the auxiliary battery; and
when the electronic control device is brought into a stopped state with the auxiliary battery disconnected from the power source circuit and thereafter the electronic control device is started with the auxiliary battery connected to the power source circuit again, the electronic control device determines whether the data have become discontinuous because of replacement of the power storage device by comparing the data recorded immediately before start of the electronic control device and the data recorded immediately after the start.

10. A vehicle management system comprising:
a vehicle that includes a power storage device and an electronic control device; and
a server configured to communicate with the vehicle, wherein
the electronic control device is configured to transmit, to the server, a measurement result of each of data about the power storage device and a position of the vehicle together with a measurement time, and
the server is configured to
save the data about the power storage device and the position of the vehicle received from the vehicle together with the measurement time,
determine whether the saved data about the power storage device have become discontinuous because of replacement of the power storage device,
determine whether the position of the vehicle at a time when the data have become discontinuous is an authorized site determined in advance when a determination that the data have become discontinuous, and
restrict use of the vehicle when the position of the vehicle at the time when the data have become discontinuous is not the authorized site.
